(19) United States
(12) Patent Application Publication
(10) Pub. No.: US 2013/0246911 A1
(43) Pub. Date: Sep. 19, 2013

(54) METHOD AND DEVICE FOR REARRANGING PARAGRAPHS OF WEBPAGE PICTURE CONTENT

(71) Applicant: Jie Liang, Beijing (CN)

(72) Inventor: Jie Liang, Beijing (CN)

(73) Assignee: US Mobile Limited

(21) Appl. No.: 13/880,976

(22) PCT Filed: Oct. 19, 2011
(86) PCT No.: PCT/CN2011/080969

§ 371 Date: May 31, 2013

(30) Foreign Application Priority Data
Oct. 21, 2010 (CN) 201010521693.0

(51) Int. Cl. G06F 17/21

(52) U.S. Cl. CPC G06F 17/212
USPC 715/243

(57) ABSTRACT

The present invention provides a method for recomposing individual characters obtained by segmenting webpage image, comprising: determining whether the line of words is the start line of a new paragraph in the webpage image based on the blank space at the beginning of the line on the webpage image being processed; when a line of words is determined as the start line of a new paragraph in the webpage image, it is set as the start line of the new paragraph being recomposed and the original blank space at the beginning of line is retained, and all of the individual characters segmented are recomposed according to the screen size of the mobile terminal; and when the line of words is determined as not the start line of a new paragraph in the webpage images, all of the individual characters segmented are recomposed so as to be immediately after the ending character of the recomposed previous line of words according to the screen size of the mobile terminal. With the aforementioned method, the segmented individual characters may be recomposed according to the screen size of the mobile terminal so as to be adapted to be displayed on screens of mobile terminals to enhance the user experience.

### TECHNICAL FIELD

The present invention relates to the field of webpage browsing, and more particularly, to a method and device for recomposing contents of webpage pictures by utilizing segmented individual characters.

### BACKGROUND ART

With the development of communication techniques, it is becoming a trend to log on novel websites to browse novel contents by mobile terminals. In order to protect the copyright of novel contents published on novel websites, picture format is adopted to show novel contents, especially some VIP chapters of a novel, by many novel websites, thereby preventing these contents to be duplicated by readers.

### DISCLOSURE OF THE INVENTION

[Technical Problem]

As the contents of novel websites are usually displayed by personal computers (PCs), the picture formats of novels showed on these novel websites are generally designed for display screens of PCs. While users log on novel websites to browse web pages through mobile terminals, novels in the picture formats can not be displayed on the small screens of mobile terminals as conveniently as on PCs, because images in picture formats usually have large size. In this case, if the novel images are zoomed out to fit the sizes of screens of mobile terminals, words are zoomed out to be too small to be read. If images are showed in original picture formats, users need to move the windows left and right repeatedly when reading such which is very inconvenient.

With respect to the abovementioned problem, contents of web images are required to be adapted to the sizes of display screens of mobile terminals, such as recomposing contents of web images, while users browse novel contents on novel websites through mobile terminals.

As novel contents are composed in character as the basic unit, the web images are required to be segmented to obtain individual characters before the contents of webpage images being composed. Method and device for segmenting characters in webpage images are described in details in CN 201010521691.1, which was filed on the same day as the present invention by the applicant, and titled “A CHARACTER SEGMENTING METHOD AND APPARATUS FOR WEB PAGE PICTURES”. The above application is incorporated in its entirety by reference.

After the characters in the web pages images are segmented as described above, the segmented individual characters are required to be recomposed so as to be adapted to be displayed on screens of mobile terminals according to the screen size of the mobile terminals.

[Technical Solution]

In light of the aforementioned, the present invention discloses a method and device for recomposing individual characters segmented based on webpage image , by which the segmented individual characters may be recomposed according to the screen size of the mobile terminal, with the composing styles of the original webpage images being retained to the largest extent, so as to be adapted to be displayed on screens of mobile terminals to enhance the user experience.

In accordance with one aspect of the present invention, a method for recomposing individual characters segmented based on webpage image to be displayed on mobile terminals is provided, the method comprises: when a line of words is determined as the start line of a new paragraph on the webpage image based on the starting blank space at the beginning of the line of words on the webpage image being processed, the line of words is set as the start line of the new paragraph subjected to recomposing, and the original starting blank space is retained, and the line of words is recomposed based on the screen size of the mobile terminal by utilizing all of the individual characters segmented from the line of words; and when the line of words is determined as not the start line of a new paragraph on the webpage images, all of the individual characters segmented from the line of words are recomposed based on the screen size of the mobile terminal so as to be immediately after the ending character of the recomposed previous line.

Furthermore, in one or more embodiments, recomposing, according to the screen size of the mobile terminal, all of the individual characters segmented based on the line of words also comprises: with regard to two characters located at a neighboring positions in the same line after being recomposed, setting the pitch of the two characters in accordance with the relationship of the locations of the two characters on the webpage image; and setting the pitches of the neighboring lines at different pitches according as the neighboring lines having been recomposed locate in the same paragraph or not.

Furthermore, if the two characters locate in the same line and are adjacent to each other on the webpage image, the pitch of the two characters is retained at the original pitch upon being recomposed.

Furthermore, if the two characters locate in different lines on the webpage image, the pitch of the two characters being set at a predetermined pitch upon being recomposed. The predetermined pitch may be, such as, an average pitch.

Furthermore, when all of the individual characters segmented based on the line of words are recomposed according to the screen size of the mobile terminal, with regard to two words located at neighboring positions in the same line of the webpage image, if the two words are not located at neighboring positions in the same line after being recomposed, the former word is determined as the last word of a line and the latter word is determined as the first word of the following line.

Furthermore, the method can be implemented by the browser of the mobile terminal, or implemented at server-side.

In accordance with another aspect of the present invention, a device for recomposing individual characters segmented based on webpage image is provided, the device comprises: a paragraph start line determining unit for determining whether a line of words that is being processed is the start line of a new paragraph on the webpage image based on the blank space at the beginning of the line of words; a recomposing device used for, based on the determining results of the paragraph start line determining unit, determining whether to recompose all of the individual characters segmented based on the line of words to be immediately after the ending character of the recomposed previous line of words according to the screen size of the mobile terminal, wherein, the recomposing unit further comprises a new paragraph processing unit which is used for, when the line of words is determined as the start line of a new paragraph on the webpage image, recomposing this line by setting the line of words as the start line of the new paragraph being recomposed and retaining the original blank space at the beginning of the line.

Furthermore, in one or more embodiments, the recomposing unit may also comprises: a character pitch determining unit used for, with regard to two characters located at neighboring positions in the same line after recomposing, setting the pitch of the two characters after being recomposed in accordance with the relationship of the locations of the two characters on the webpage image; and a neighboring lines pitch determining unit used for setting the pitches of the neighboring lines as different pitches according as the neighboring lines subjected to recomposing locate in the same paragraph or not.

Furthermore, if the two characters locate in the same line and are adjacent to each other on the webpage image, the pitch of the two characters is set as the original pitch by the character pitch determining unit.

Furthermore, the pitch of the two characters is set at a predetermined pitch by the character pitch determining unit, if the two characters locate in different lines on the webpage image.

Furthermore, for two words locate in the same line and are adjacent to each other on the webpage image, if the two words are not located at neighboring locations in the same line, the former word is determined as the last word of a line and the latter word is determined as the first word of the following line.

Furthermore, the device may be installed in the browser of the mobile terminal.

A mobile terminal comprising the aforementioned device is provided in accordance with yet another aspect of the present invention.

A server comprising the aforementioned device is provided in accordance with yet another aspect of the present invention.

[Advantageous Effects]

By utilizing the aforementioned method and device, the segmented individual characters may be recomposed according to the screen size of the mobile terminal, while the composing styles of the webpage images being retained to the largest extent, so as to be adapted to be displayed on screens of mobile terminals to enhance the user experience.

In order to achieve the above and other related objects, one or more aspects of the present invention include those features to be described in detail in the followings and particularly defined in the claims. The following descriptions and accompanying drawings describe in detail certain illustrative aspects of the present invention. However, these aspects only illustrate some of the ways in which the principle of the present invention can be used. In addition, the present invention intends to include all these aspects and their equivalents.

### BRIEF DESCRIPTION OF THE DRAWINGS

By way of the following description with reference to the accompanying drawings and the claims, and with a full understanding of the present invention, other purposes and effects of the present invention will be more apparent and easily understandable. In the drawings:

FIG. 1 shows a flow chart of the method for recomposing individual characters segmented based on webpage images to be displayed on mobile terminals according to an embodiment of the present invention;

FIG. 2 shows a schematic block diagram of the recomposing device for recomposing individual characters segmented based on webpage images to be displayed on mobile terminals according to an embodiment of the present invention;

FIG. 3 shows a mobile terminal comprising the recomposing device according to the present invention; and

FIG. 4 shows a server comprising the recomposing device according to the present invention.

Similar signs throughout all figures indicate similar or corresponding features or functions.

### EMBODIMENTS OF THE INVENTION

Various specific details are set forth in the following description to comprehensively understand one or more embodiments for sake of illustration. However, it is obvious that these embodiments can be implemented without such specific details. In other examples, known structures and devices are shown by block diagrams for convenience in describing one or more embodiments. And those skilled in the art will readily understand that, the term “character” used throughout this application refers to a basic unit of language when displayed on a computer screen or on a mobile terminal, for example, in Chinese language, “character” may refer to a Chinese character, and in English, it may refers to an English word.

Hereinafter, various embodiments of the present invention will be described in detail with reference to the drawings.

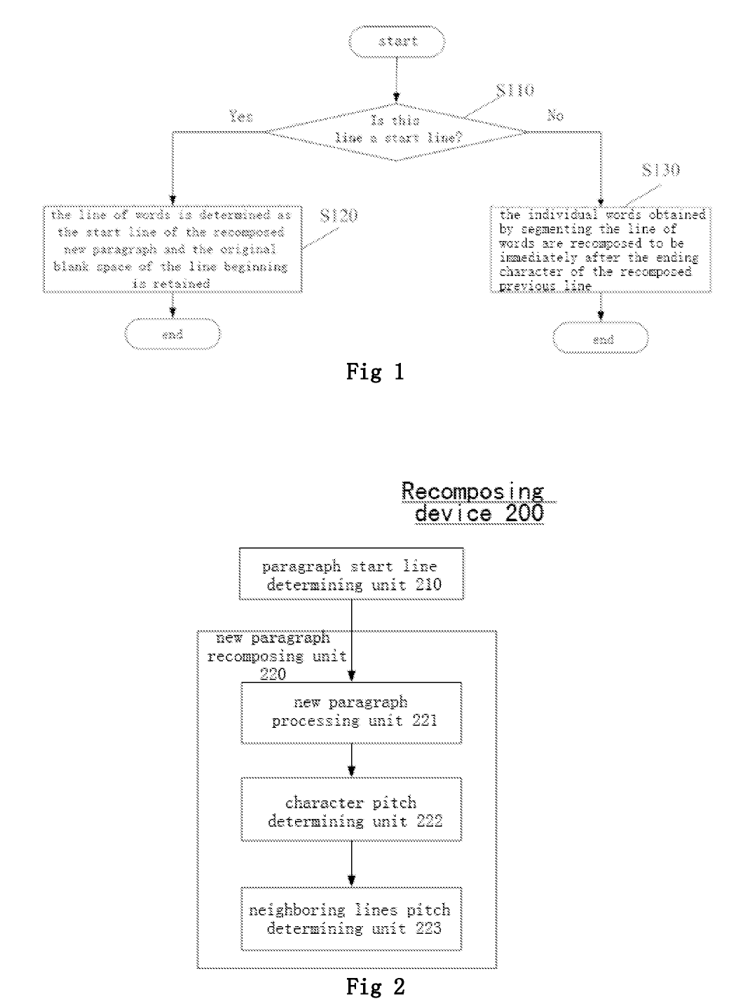

FIG. 1 shows the flow chart of the method for recomposing individual characters obtained by segmenting webpage images and displaying on mobile terminals according to one embodiment of the present invention.

First, in step S110, for a line of words in a webpage image being processed, it is determined whether the line of words is the start line of a new paragraph on the webpage image based on the blank space at the beginning of the line of words, as showed in FIG. 1. For example, an average value of the blank spaces at the beginning of all lines on the webpage image may be calculated firstly. Then, whether the blank space at the beginning of the line of words is larger than the average value is determined If the blank space at the line beginning of a line of words is greater than the average value, the line of words is considered as the start line of a new paragraph. Otherwise, the line of words is considered as a following line of the original paragraph. Other methods can also be used to determine whether a line of words is the start line of a new paragraph, for example, the users assign a threshold range in advance, and the line of words is determined as the start line of a new paragraph when the size of the blank space at the beginning of the line falls into the threshold range.

When a line of words is determined as the start line of a new paragraph on the webpage image, the procedure processes to step S120. In step S120, the line of words is determined as the start line of the recomposed new paragraph and the original blank space at the beginning of the line is retained in the recomposed paragraph, and then the line of words are recomposed according to the screen size of the mobile terminal with the individual characters segmented based on said line of words.

In step S130, when the line of words is determined as not the start line of a new paragraph on the webpage image, the line of words are recomposed immediately after the ending character of the recomposed previous line of words according to the screen size of the mobile terminal with all of the individual characters segmented based on said line of words.

When recomposing is performed according to the screen size of the mobile terminal with respect to all of the individual characters segmented based on the line of words, the recomposed neighboring characters and neighboring lines are required to set pitches in accordance with the following method.

With regard to two characters located at neighboring positions in a same line after recomposing, the pitch of the two characters after being recomposed is set in accordance with the relationship of the locations of the two characters on the webpage image. In particular, if the two characters locate in the same line and are adjacent to each other on the webpage image, the pitch of the two characters is retained at the original pitch after being recomposed, said original pitch refers to the pitch between the two characters on the webpage image before being segmented. If the two characters locate in different lines on the webpage image, the pitch of the two characters is set at a predetermined pitch. For example, the predetermined pitch may be an average pitch of neighboring characters on the webpage image or an average pitch of recomposed characters. Obviously, the predetermined pitch may be an arbitrary pitch as required by users.

Furthermore, when recomposing is performed according to the screen size of the mobile terminal with respect to all of the individual characters obtained by segmenting the line of words, with regard to two words located at neighboring positions in the same line of the webpage image, if after recomposing the two words are not located neighboring positions in the same line, the former word is determined as the last word of a line and the latter word is determined as the first word of the following line.

Also, when all of the segmented individual characters are recomposed according to the screen size of the mobile terminal, pitches between neighboring lines are also required to be set as different pitches according to whether the neighboring lines subjected to recomposing are located in the same paragraph or not. As an example, if the two neighboring lines subjected to recomposing are located at the same paragraph, the pitch of the two neighboring lines is set as one-sixth of the average line-height. If the two neighboring lines subjected to recomposing are not located at the same paragraph, the pitch of the two neighboring lines is set as half of the average line-height.

It is noted herein that the abovementioned method can be implemented by the browser of a mobile terminal, or implemented at server-side.

When the abovementioned method is implemented by the browser of a mobile terminal, the browser generally has powerful functions. When the abovementioned method is implemented by the server, the URLs required to be browsed are transmitted to the server by the browser client of the mobile terminal and the information of the size of screen (in unit of pixel) of mobile terminal is transmitted to the server, and then the server obtains webpage data from the URL and resolves and recomposes the webpage. After recomposing, recomposed results are transmitted to the browser clients by the server.

The method for recomposing individual characters obtained by segmenting webpage images and displaying them on mobile terminals according to the present invention is described with reference to FIG. 1. The above method for recomposing individual characters obtained by segmenting webpage images and displaying them on mobile terminals in accordance with the present invention may be implemented with software, hardware, or a combination of software and hardware.

FIG. 2 shows a schematic block diagram of the recomposing device 200 for recomposing individual characters obtained by segmenting webpage images for displaying on mobile terminals according to one embodiment of the present invention. The recomposing device 200 comprises a paragraph start line determining unit 210 and a recomposing unit 220 as showed in FIG. 2. The recomposing unit further comprises a new paragraph processing unit 221.

Whether the line of words is a start line of a new paragraph on the webpage image is determined by the paragraph start line determining unit 210 based on the blank space at the beginning of the line of words on the webpage image being processed.

Based on the results determined by the paragraph start line determining unit, the recomposing unit 220 determines whether to recompose all of the individual characters obtained by segmenting the line of words according to the screen size of the mobile terminal so as to be immediately after the ending character of the recomposed previous line of words.

When the line of words is determined as the start line of the new paragraph on the webpage image, the new paragraph processing unit 221 of the recomposing unit 220 sets the line of words as the start line of the new paragraph being recomposed and the original blank space at the beginning of the line is retained there, and all of the individual characters obtained by segmenting the line of words are recomposed according to the screen size of the mobile terminal.

When the line of words is determined as not the start line of a new paragraph on the webpage images, the recomposing unit 220 recomposes the line of words so as to be immediately after the ending character of the recomposed previous line of words.

Furthermore, the recomposing unit 220 may also comprises a character pitch determining unit 222 and a neighboring lines pitch determining unit 223. The character pitch determining unit 222 is used for, with regard to two characters located at neighboring positions in the same line after being recomposed, setting the pitch of the two characters in accordance with the relationship of the locations of the two characters on the webpage image. The neighboring lines pitch determining unit 223 is used for setting the pitches of the neighboring lines at different pitches according as the neighboring lines having been recomposed locate in the same paragraph or not.

If the two characters locate in the same line and are adjacent to each other on the webpage image, the pitch of the two characters is set at the original pitch by the character pitch determining unit 222. If the two characters locate in different lines on the webpage image, the pitch of the two characters is set at a predetermined pitch by the character pitch determining unit 222.

Furthermore, for two words locate in the same line and are adjacent to each other on the webpage image, if the two words do not locate in the same line after being recomposed, the former word is determined as the last word of a line and the latter word is determined as the first word of a following line by the recomposing unit 220, and the distance between the first word and the last word in the following line is preset as the blank space at the beginning of a line plus the blank space at the end of a line in the same paragraph.

Furthermore, when all of the segmented individual characters are recomposed according to the screen size of the mobile terminal, pitches between neighboring lines are set at different pitches by the neighboring lines pitch determining unit 223 according as the neighboring lines having been recomposed are located in the same paragraph or not. As an example, if the two neighboring lines subjected to recomposing are located in the same paragraph, the pitch of the two neighboring lines is set at one-sixth of the average line-height. If the two neighboring lines subjected to recomposing are not located in the same paragraph, the pitch of the two neighboring lines is set at half of the average line-height.

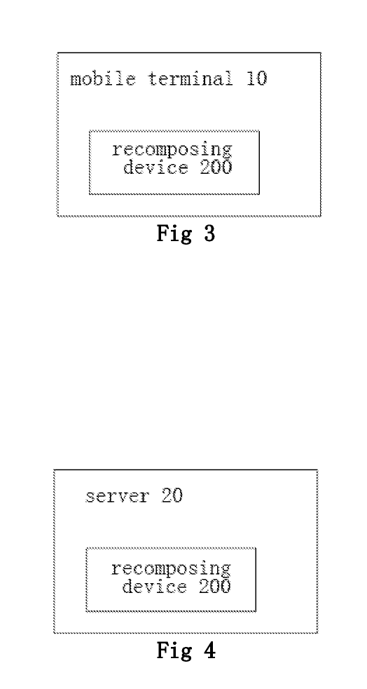

It is noted herein that the device may be installed in the browser of a mobile terminal or at the server-side. FIG. 3 shows the mobile terminal 10 comprising the recomposing device 200 according to the present invention. FIG. 4 shows the server 20 comprising the recomposing device 400 according to the present invention.

The mobile terminals described in the present invention may typically be various terminal devices capable of browsing web pages, such as mobile phones, personal digital assistants and the like. Therefore, the scope of the present invention should not be limited to certain specific mobile terminals.

In addition, the method according to the present invention may also be implemented in CPU-executable computer programs. When executed by the CPU, the computer programs perform the above functions defined in the method according to the present invention.

In addition, the above steps included in the method and system units can be realized by a controller or processor, and by computer-readable storage medium storing computer programs capable of making the controller or processor to implement the above steps or functions of the system units.

In addition, it should be understood that the computer-readable storage medium described herein (e.g., memory) can be volatile memory or nonvolatile memory, or can include both volatile memory and nonvolatile memory. As a non-limiting example, nonvolatile memory may include read-only memory (ROM), programmable ROM (PROM), electrically programmable ROM (EPROM), electrically erasable programmable ROM (EEPROM), or flash memory. Volatile memory may include random access memory (RAM), which may act as external cache memory. As another non-limiting example, the RAM can be obtained in various forms such as synchronous RAM (SRAM), dynamic RAM (DRAM), synchronous DRAM (SDRAM), double data rate SDRAM (DDR SDRAM), enhanced SDRAM (ESDRAM), synchronous link DRAM (SLDRAM), and direct Rambus RAM (DRRAM). It is intended that the disclosed storage medium is including but not limited to these and other suitable types of memory.

Those skilled in the art will understand that, the described various exemplary logic blocks, modules, circuits, and algorithm steps can be implemented in electronic hardware, computer software, or a combination thereof. In order to clearly illustrate this interchangeability between hardware and software, functions of a variety of schematic components, blocks, modules, circuits, and steps are generally described. Whether the functions are implemented in software or hardware depends on the specific application and design constrains applied to the entire system. Those skilled in the art can, for each specific application, use a variety of ways to realize the described functions. However, such specific realization should not be interpreted as departing from the scope of the present invention.

The various exemplary logic blocks, modules, and circuits described here, can be designed as the following components performing the functions described here: general-purpose processor, digital signal processor (DSP), application specific integrated circuits (ASICs), field programmable gate array (FPGA) or other programmable logic device, discrete gate or transistor logic, discrete hardware components, or any combination of these components. The general-purpose processor can be a microprocessor, alternatively, the processor can be any conventional processor, controller, microcontroller or state machine. The processor can also be a combination of computing devices, such as a combination of DSP and microprocessors, multiple microprocessors, one or more microprocessors integrated with a DSP core, or any other such configuration.

The disclosed methods or algorithm steps, in combination of the disclosure herein, may be embodied directly in hardware, software modules executed by the processor, or a combination of both. The software module can reside in RAM memory, flash memory, ROM memory, EPROM memory, EEPROM memory, registers, hard disk, removable disk, the CD-ROM, or any other form of storage medium known in the art. The exemplary storage medium can be coupled to the processor, such that the processor can read information from the storage medium and write information to the storage medium. Alternatively, the storage medium can be integrated with the processor. The processor and the storage medium may reside in an ASIC. The ASIC can reside in the user terminal. Also alternatively, the processor and the storage medium may reside as discrete components in the user terminal.

While the invention has been shown by the above disclosure, it should be noted that various modification and variation can be made therein without departing from the scope of the invention as defined by the appended claims. The functions, steps and/or operations of the method claim in accordance with the embodiments of the invention described here are not necessary to be implemented in specific order. Moreover, although elements mentioned in the present invention can be described or claimed in an individual form, a plurality of elements can be conceived, unless there is a clear limit for singular.

Although the present invention is disclosed in combination of the preferable embodiments showed and described in details, it should be understood by those skilled in the art that, as to the above method and device for recomposing individual characters segmented based on webpage images to be displayed on mobile terminals set forth in the present invention, various improvements can be made without escape the content of the present invention. Accordingly, the scope of protection of the present invention is determined by the contents of the appended claims.

1. A method for recomposing individual characters obtained by segmenting contents of a webpage image, comprising:
when a line of words in a webpage image being processed is determined as a start line of a new paragraph, setting the line of words as the start line of the new paragraph being recomposed, and recomposing all of the individual characters obtained by segmenting the line of words according to the screen size of the mobile terminal; and
when the line of words is determined as not the start line of a new paragraph, recompose all of the individual characters obtained by segmenting the line of words so as to be immediately after the ending character of the recomposed previous line of words according to the screen size of the mobile terminal.

2. The method according to claim 1, wherein the step of recomposing all of the individual characters obtained by segmenting the line of words according to the screen size of the mobile terminal further comprises:
setting, with regard to two characters located at neighboring positions in the same line after being recomposed, the pitch of the two characters while being recomposed in accordance with the relationship of the locations of the two characters on the webpage image; and
setting the pitches of the neighboring lines at different pitches according as the neighboring lines having been recomposed locate in the same paragraph or not.

3. The method according to claim 2, wherein setting the pitch of the two characters while being recomposed in accordance with the relationship of the locations of the two characters on the webpage image comprises:
the pitch of the two characters being retained at the original pitch while being recomposed, if the two characters locate in the same line and are adjacent to each other on the webpage image.

4. The method according to claim 2, wherein setting the pitch of the two characters while being recomposed in accordance with the relationship of the locations of the two characters on the webpage image comprises:
the pitch of the two characters being set at a predetermined pitch while being recomposed, if the two characters locate in different lines on the webpage image.

5. (canceled)

6. A device for recomposing individual characters obtained by segmenting webpage images so as to be displayed on mobile terminals, comprising:
a paragraph start line determining unit for determining whether a line of words on the webpage image being processed is the start line of a new paragraph;
a recomposing device for, based on the results determined by the paragraph start line determining unit, determining whether to recompose, according to the screen size of the mobile terminal, all of the individual characters obtained by segmenting the line of words so as to be immediately after the ending character of the recomposed previous line of words,
wherein, the recomposing unit further comprises a new paragraph processing unit, which is used for, when the line of words is determined as the start line of the new paragraph on the webpage image, setting the line of words as the start line of the new paragraph being recomposed and retaining the original blank space at the beginning of the line.

7. The device according to claim 6, wherein, the recomposing unit further comprises:
a character pitch determining unit used for, with regard to two characters located at neighboring positions in the same line after being recomposed, setting the pitch of the two characters while being recomposed in accordance with the relationship of the locations of the two characters on the webpage image; and
a neighboring lines pitch determining unit for setting the pitches of neighboring lines at different pitches according as the neighboring lines having been recomposed locate in the same paragraph or not.

8. The device according to claim 7, wherein, the character pitch determining unit is also used for setting the pitch of the two characters as the original pitch if the two characters locate in the same line and are adjacent to each other on the webpage image.

9. The device according to claim 7, wherein, the pitch of the two characters is set at a predetermined pitch by the character pitch determining unit, if the two characters locate in different lines on the webpage image.

10. The device according to claim 6, wherein, with regard to two words located at neighboring positions in the same line of the webpage image, if the two words are not located at neighboring positions in the same line after being recomposed, the former word being determined as the last word of a line and the latter word being determined as the first word of the following line by the recomposing unit.

11. A mobile terminal comprising any-of the device according to claim 6.

12. A server comprising any-of the device according to claims 6.

13. The method according to claim 1, wherein the step of determining whether a line of words in a webpage image being processed is a start line of a new paragraph comprises:
calculating the average size of the blank spaces at the beginning of all lines on the webpage image;
determining the size of the blank space at the beginning of a line;
if the size of the blank space at the beginning of the line is larger than the average size, then it's determined the line is a start line of a new paragraph;
if the size of the blank space at the beginning of the line is smaller than the average size, then it's determined the line is not a start line of a new paragraph.

14. The method according to claim 1, wherein the step of determining whether a line of words in a webpage image being processed is a start line of a new paragraph comprises:
determining the size of the blank space at the beginning of a line;
if the size of the blank space at the beginning of the line is larger than a preset threshold value, then it's determined the line is a start line of a new paragraph;
if the size of the blank space at the beginning of the line is smaller than the preset threshold value, then it's determined the line is not a start line of a new paragraph.

15. The method according to claim 1, wherein the step of determining whether a line of words in a webpage image being processed is a start line of a new paragraph comprises:
determining the pitch between a line of words and a immediate preceding line;
if the pitch is larger than a preset threshold value, then it's determined the line is a start line of a new paragraph;
if the pitch is smaller than a preset threshold value, then it's determined the line is not a start line of a new paragraph.

16. The device according to claim 6, wherein, based on the blank space at the beginning of the line of words, the paragraph start line determining unit determines whether a line of words on the webpage image being processed is the start line of a new paragraph.

17. The device according to claim 6, wherein, based on the pitch between a line of words and the immediate preceding line, the paragraph start line determining unit determines whether a line of words on the webpage image being processed is the start line of a new paragraph.

18. A computer program, which may be run on a mobile terminal or on a server to implement the method of claim 1.
